(19) United States
(12) Patent Application Publication
(10) Pub. No.: US 2007/0273548 A1
(43) Pub. Date: Nov. 29, 2007

(54) Remote Monitor in Electric Home Appliances

(75) Inventors: Yang Hwan No, Gyeongsangnam-do (KR); Han Ki Cho, Gyeongsangnam-do (KR); Ho Sung Jang, Gyeongsangnam-do (KR)

Correspondence Address: MCKENNA LONG & ALDRIDGE LLP, 1900 K STREET, NW, WASHINGTON, DC, 20006, US

(73) Assignee: LG ELECTRONICS INC., Youngdungpo-gu (KR)

(21) Appl. No.: 10/562,507

(22) PCT Filed: Nov. 9, 2005
(86) PCT No.: PCT/KR05/03782

§ 371 Date: Apr. 30, 2007

(30) Foreign Application Priority Data
Nov. 10, 2004 (KR) P2004-91351
Nov. 10, 2004 (KR) P2004-91352
Nov. 10, 2004 (KR) P2004-91354
Nov. 15, 2004 (KR) P2004-92936

(51) Int. Cl. G08C 19/00

(52) U.S. Cl. 340/870.01

(57) ABSTRACT

Remote monitor for remote, and easy monitoring and control of a state of a home appliance. To achieve this, the present invention provides a remote monitor for a home appliance, the remote monitor being connected to at least one home appliance with a predetermined communication system for displaying, and controlling of a state of the home appliance at a place far from the home appliance, including a case forming an outside appearance of the remote monitor, including a lower case, an upper case detachably mounted on an upper side of the lower case, the upper case having a window, and an outer case detachably mounted on an upper side of the upper case, the outer case having a display window in correspondence to the window, and a control board in the case, the control board having various electronic components mounted thereon.

### TECHNICAL FIELD

The present invention relates to home appliances, and more particularly, to a remote monitor for remote, and easy monitoring and control of a state of a home appliance, such as a washing machine, or dryer far from a user.

### BACKGROUND ART

In general, the home appliance, an apparatus for operating by using electricity in a home, converts the electricity into a light, heat, or power, for convenience of a home life.

Recently, different from other home appliances, since a washing machine, or a dryer using electricity as power, not only occupies a large installation space, but also has big noise and vibration generated when the washing machine or dryer is operated, the washing machine, or a dryer is in general installed at a place, such as veranda, far from a living room.

Particularly, due to structures of most houses in the USA, and Europe, the washing machine is installed in a cellar, or separate warehouse, or the like, far from an actual living space.

Thus, the installation of the washing machine far from a living room where a user stays most of time causes difficulty in knowing progress of the washing machine, such as the present cycle of the washing machine or a time period left, easily.

That is, it is required for the user to go to the place where the washing machine is from time to time, for determining a state of progress of the washing machine every time, personally.

Moreover, after putting the washing machine into operation, if the user forgets a fact that the user put the washing machine into operation for a moment or completely, the laundry finished washing rumples, or has microbes increased thereon, to damage the laundry.

Furthermore, the user is liable to fail to notice an error in the cycle of the washing machine, to fail in taking a proper countermeasure, leaving the laundry in contact with detergent and the washing water for a long time to cause decoloring of the laundry, thereby damaging cloth of the laundry itself.

### DISCLOSURE

### Technical Problem

The object of the present invention, designed for solving the problems of the related art, lies on providing a remote monitor for a home appliance, which enables easy and remote monitoring and control of a state of a home appliance, such as a washing machine, or dryer far from a user, for convenient and effective use of the home appliance.

### Technical Solution

To achieve the object of the present invention, a remote monitor for a home appliance, the remote monitor being connected to at least one home appliance with a predetermined communication system for displaying, and controlling of a state of the home appliance at a place far from the home appliance, includes a case forming an outside appearance of the remote monitor, including a lower case, and an upper case detachably mounted on an upper side of the lower case, the upper case having a window, and a control board in the case, the control board having various electronic components mounted thereon.

In another aspect of the present invention, a remote monitor for a home appliance, the remote monitor being connected to at least one home appliance with a predetermined communication system for displaying, and controlling of a state of the home appliance at a place far from the home appliance, including a case forming an outside appearance of the remote monitor, including a lower case, an upper case detachably mounted on an upper side of the lower case, the upper case having a window, and an outer case detachably mounted on an upper side of the upper case, the outer case having a display window in correspondence to the window, and a control board in the case, the control board having various electronic components mounted thereon.

In another aspect of the present invention, a remote monitor for a home appliance, the remote monitor being connected to at least one home appliance having a power line communication modem with a power line communication system for displaying, and controlling of a state of the home appliance at a place far from the home appliance, including a case forming an outside appearance of the remote monitor, including a lower case, a control board having a communication modem board on the lower case for transmission/reception of data to/from the modem at the home appliance through a power line, and a display board mounted on an upper side of the communication modem board securely, or detachably, for displaying a state of the home appliance to an outside, an upper case detachably mounted on an upper side of the lower case, the upper case having a window for exposing a display portion of the display board, a see-through sheet on an upper side of the upper case for enabling see-through, and a protective sheet on the see-through sheet having a see-through window corresponding to the window of the upper case.

In another aspect of the present invention, a remote monitor for a home appliance, the remote monitor being connected to at least one home appliance having a power line communication modem with a power line communication system for displaying, and controlling of a state of the home appliance at a place far from the home appliance, including a case forming an outside appearance of the remote monitor, including a lower case, a control board having a communication modem board on the lower case for transmission/reception of data to/from the modem at the home appliance through a power line, and a display board mounted on an upper side of the communication modem board securely, or detachably, for displaying a state of the home appliance to an outside, an upper case detachably mounted on an upper side of the lower case, the upper case having a window for exposing a display portion of the display board, an outer case detachably mounted on an upper side of the upper case having a display window corresponding to the window, a see-through sheet on an upper side of the outer case for enabling see-through, and a protective sheet on the see-through sheet having a see-through window corresponding to the display window of the outer case.

### ADVANTAGEOUS EFFECTS

The remote monitor for a home appliance of the present invention has the following advantages.

First, user's easy and remote monitoring of a home appliance is permitted,

Second, the user can to take an appropriate measure at an appropriate time, thereby permitting effective maintenance and management of the home appliance,

Third, the user can make effective management of things, such as laundry, used for the home appliance.

### DESCRIPTION OF DRAWINGS

The accompanying drawings, which are included to provide a further understanding of the invention, serve to explain the principle of the invention together with the description. In the drawings;

FIG. 1 illustrates a diagram showing a state of use of a remote monitor in accordance with a preferred embodiment of the present invention, schematically;

FIG. 2 illustrates a perspective view of a remote monitor in accordance with a first preferred embodiment of the present invention;

FIG. 3 illustrates an exploded perspective view of the remote monitor in FIG. 2;

FIG. 4 illustrates a bottom perspective view of the outer case and the upper case in FIG. 3;

FIG. 5 illustrates a section across a line I-I in FIG. 2;

FIG. 6 illustrates a section across a line II-II in FIG. 2;

FIG. 7 illustrates an enlarged sectional view of “A” part in FIG. 5 in a state the upper case and the lower case are separated from each other;

FIG. 8 illustrates an enlarged sectional view of “B” part in FIG. 5 in a state the outer case and the upper case are separated from each other;

FIG. 9 illustrates a perspective view of a top side of an operation button;

FIG. 10 illustrates a perspective view of a bottom side of an operation button;

FIG. 11 illustrates a perspective view of a remote monitor in accordance with a first preferred embodiment of the present invention in a state the remote monitor is mounted on a hanger;

FIG. 12 illustrates a perspective view of a remote monitor in accordance with a second preferred embodiment of the present invention;

FIG. 13 illustrates an exploded perspective view of the remote monitor in FIG. 12;

FIG. 14 illustrates a bottom perspective view of the outer case and the upper case in FIG. 13;

FIG. 15 illustrates a section across a line III-III in FIG. 12;

FIG. 16 illustrates a section across a line IV-IV in FIG. 12;

FIG. 17 illustrates an enlarged sectional view of “C” part in FIG. 15 in a state the upper case and the lower case are separated from each other;

FIG. 18 illustrates an enlarged sectional view of “D” part in FIG. 15 in a state the outer case and the upper case are separated from each other;

FIG. 19 illustrates a perspective view of a top side of an operation button;

FIG. 20 illustrates a perspective view of a bottom side of an operation button; and

FIG. 21 illustrates a perspective view of a remote monitor in accordance with a second preferred embodiment of the present invention in a state the remote monitor is mounted on a hanger.

### BEST MODE

Reference will now be made in detail to the preferred embodiments of the present invention, examples of which are illustrated in the accompanying drawings.

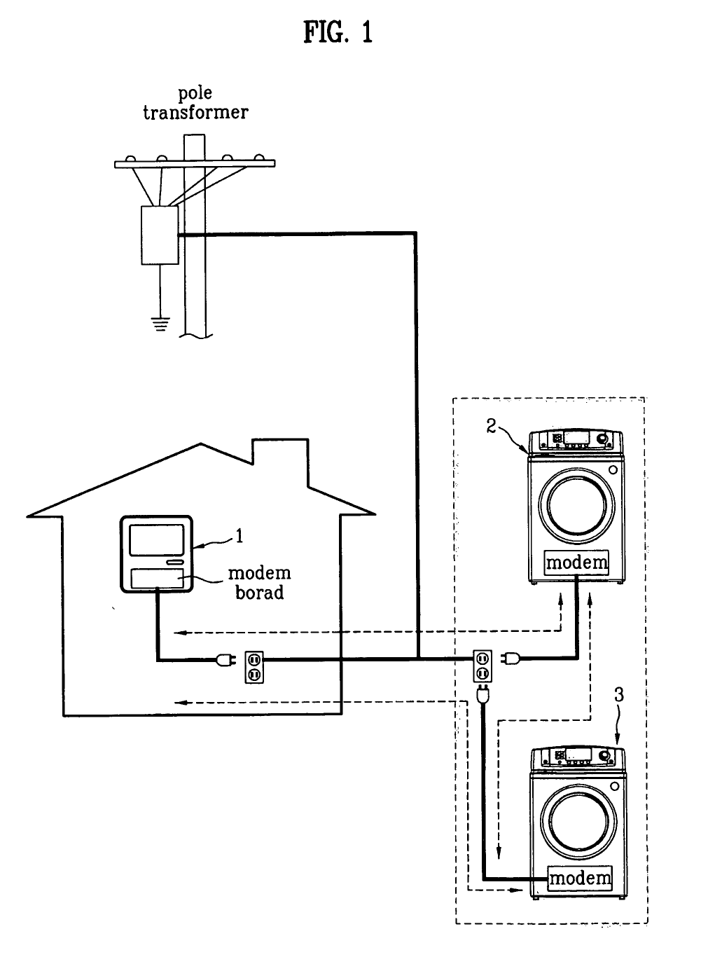

The remote monitor for a home appliance in accordance with a first preferred embodiment of the present invention will be described with reference to FIGS. 1 to 11.

Referring to FIG. 1, the remote monitor 1 is mounted at a place where a user stays much of time, such as a living room, or a bed room, or the like, while home appliances, such as a washing machine 2 and a dryer 3, are installed at space (a veranda, or a cellar) far from the living room, or the bed room.

The remote monitor 1 is connected to the home appliances, such as the washing machine 2 and the dryer 3, with a power line communication system.

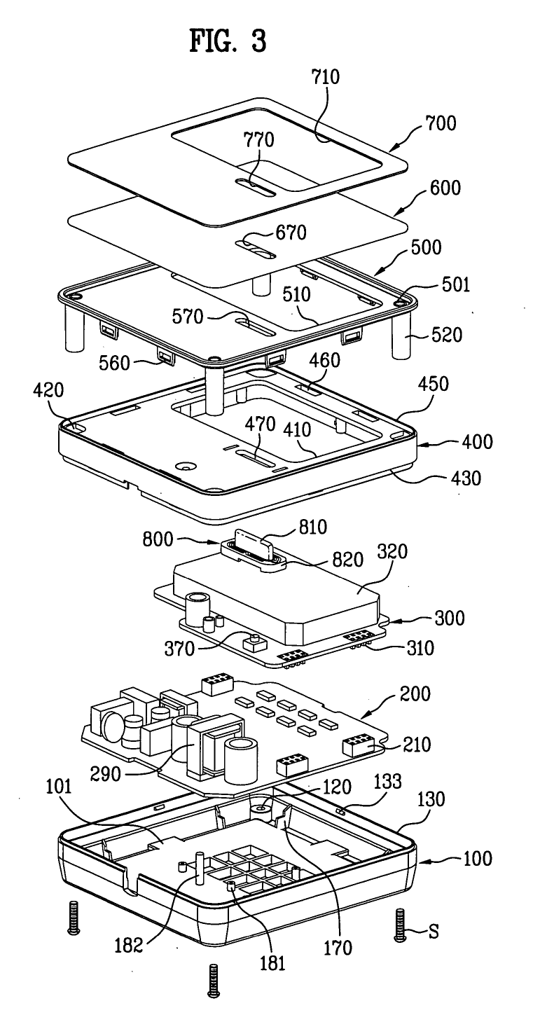

That is, the washing machine 2 and the dryer 3 have power line communication modems provided thereto respectively, and the remote monitor 1 has a board 200 (see FIG. 3) of a power line communication modem, for making data transmission/reception to/from the power line communication modems at the washing machine 2 and the dryer 3 through power line, respectively.

Accordingly, once the washing machine 2 and the dryer 3 are connected to the power line through a plug receptacle, and the remote monitor 1 is connected to the power line, the remote monitor 1 makes data transmission/reception to/from the washing machine 2 and the dryer 3 through the power line, and, not only displays progress of the washing machine 2 and the dryer 3 to an outside, but also controls the washing machine 2 and the dryer 3.

A structure of the remote monitor 1 will be described in more detail.

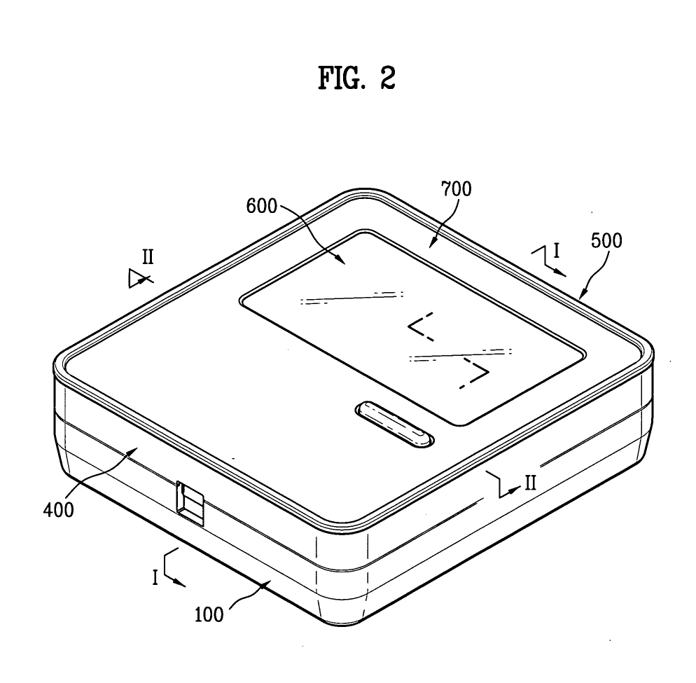

Referring to FIGS. 2 and 3, the remote monitor includes a lower case 100, a communication modem board 200 in the lower case 100, a display board 300 on the communication modem board 200, an upper case 400 on the lower case 100, an outer case 500 on the upper case 400.

The lower case 100 is rectangular substantially, with an opened top, to form a space therein, and the upper case 400 is rectangular substantially, with an opened bottom, to form a space therein, for coupling to an upper side of the lower case 100.

The communication modem board 200 is placed in the space of the lower case 100, and the display board 300 is mounted on the communication modem board 200, securely, or detachably.

The display board 300 has male terminal pins 310 at opposite edges, and the communication modem board 200 has female terminal pins 210 at opposite edges, wherein the display board 300 is electrically connected to, or disconnected from an upper side of the communication modem board 200 as male terminal pins 310 at opposite edges of the display board 300 are connected to, or disconnected from female terminal pins 210 at opposite edges of the communication modem board 200, respectively.

Of course, the display board 300 may have female terminal pins, and the communication modem board 200 may have male terminal pins, for the display board 300 to be electrically connected to, or disconnected from the upper side of the communication modem board 200.

The upper case 400 has a window 410 for showing an LCD segment 320, which is a display portion of the display board 300, and is detachably secured to the upper side of the lower case 100.

In this instance, the LCD segment 320 is detachably fastened to the display board 300 by a screw fastening system, or a hook fastening system, for displaying state information, such as a course progress, a cycle time period, and so on of the home appliance with numerals, characters, and so on.

The outer case 500 has a display window 510 in conformity with the window 410 of the upper case 400, and detachably secured to an upper side of the upper case 400.

Structures of the lower case 100, the upper case 400, and the outer case 500 will be described in more detail.

The outer case 500 has downward fastening bosses 520 at corners of a bottom surface which is a non-exposed surface, the upper case 400 has pass through holes 420 for the fastening bosses 520, and the lower case 100 has fastening holes 120 in upward projections toward an upper side thereof which is a non-exposed surface.

Accordingly, the outer case 500, the upper case 400, and the lower case 100 are assembled at a time, as screws ‘S’, fastening members, are fastened to the fastening bosses 520 through the fastening holes 120 while forming threads respectively in a state the fastening bosses 520, passed through the pass through holes 420, are in contact with the fastening holes 120 respectively.

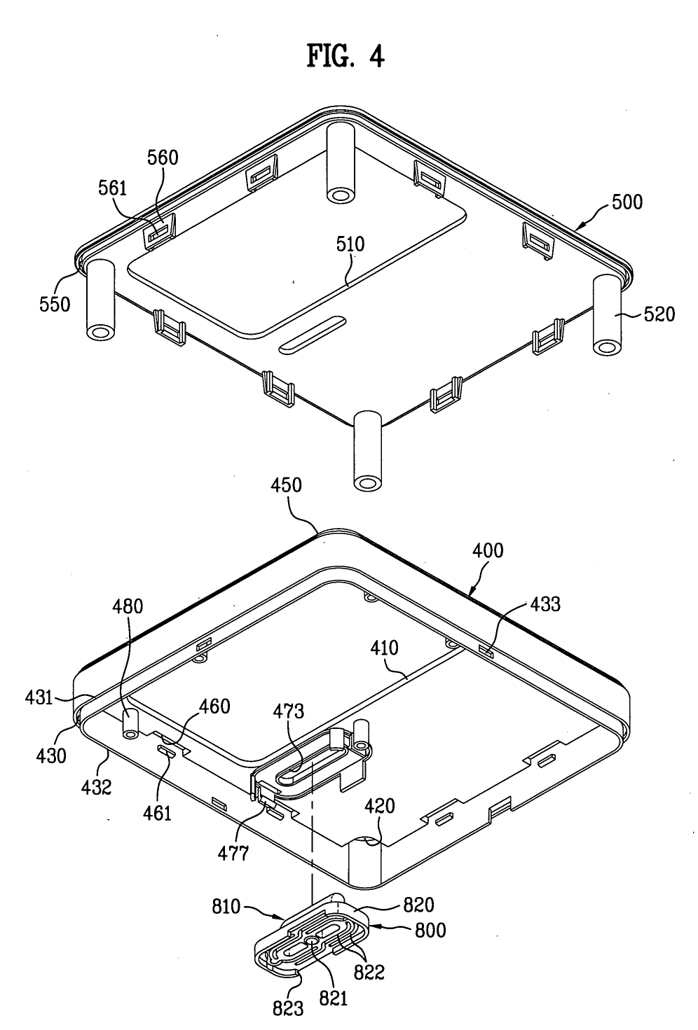

In the meantime, the lower case 100 has an upper rim 130 along an upper side circumference, and the upper case 400 has a lower groove 430 (see FIG. 4) along a lower side circumference to be engaged with the upper rim 130.

Of course, the upper case 400 may have a lower rim along a lower side circumference, and the lower case 100 may have an upper groove along an upper side circumference.

As the lower groove 430 is formed at a lower side circumference of the upper case 400, the upper case 400 becomes to have double shelled, with an outer rim 431 (see FIG. 4) on an outer side of the lower groove 130, and an inner rim 432 (see FIG. 4) on an inner side of the lower groove 130.

The inner rim 432 is projected longer than the outer rim 431, for enhancing a close contact capability of an inner side of the upper rim 130 with the inner rim 432, so that the upper case 400 and the lower case 100 are coupled firmly for protection of infiltration of water.

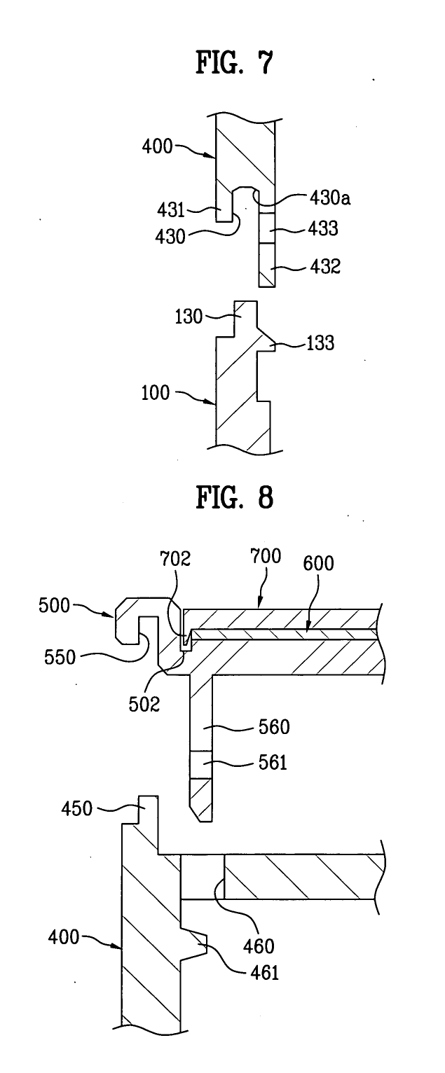

The lower groove 430 of the upper case 400 has a sealing portion 430a (see FIG. 7) where opposite edges of an end of the upper rim 130 are pressed down at the time the lower groove 430 is engaged with the upper rim 130.

The sealing portion 430a has sloped surfaces for pressing down the opposite edges of the end of the upper rim 130 thereon, respectively.

Moreover, the lower case 100 has a plurality of hooks 133 (see FIG. 7) at regular intervals along an inner side surface of the upper rim 130, and the upper case 400 has a plurality of hook holes 433 (see FIG. 7) in the inner rim 432 at positions matched to the plurality of hooks 133 for engagement with the plurality of hooks 133.

Therefore, if the upper rim 130 of the lower case 100 is engaged with the lower groove 430 of the upper case 400, the hooks 133 on the lower case 100 are engaged with the hook holes 433 in the upper case 400, thereby making the upper, and lower case coupled firmly.

In the meantime, referring to FIG. 4, the upper case 400 has an upper rim 450 along an upper side circumference, and the outer case 500 has a lower groove 550 for engagement with the upper rim 450.

The outer case 500 has holding portions 560 each having a hook hole 561 projected downward from an inner side of the circumference of a lower surface.

The upper case 400 also has slots 460 for pass through of the holding portions 560 respectively, and, along with this, hooks 461 for engagement with the hook holes 561 in the holding portions 560.

The holding portions 560 are formed at regular intervals along the circumference of the outer case 500.

Accordingly, when the holding portions 560 of the outer case 500 pass through the slots in the upper case 400, the hook holes 561 in the holding portions 560 are hooked at the hooks 461 on the upper case 400, respectively.

At the same time with this, if the upper rim 450 on the upper side circumference of the upper case 400 is engaged with the lower groove 550 of the outer case 500, the upper case 400 is coupled to the outer case 500, firmly.

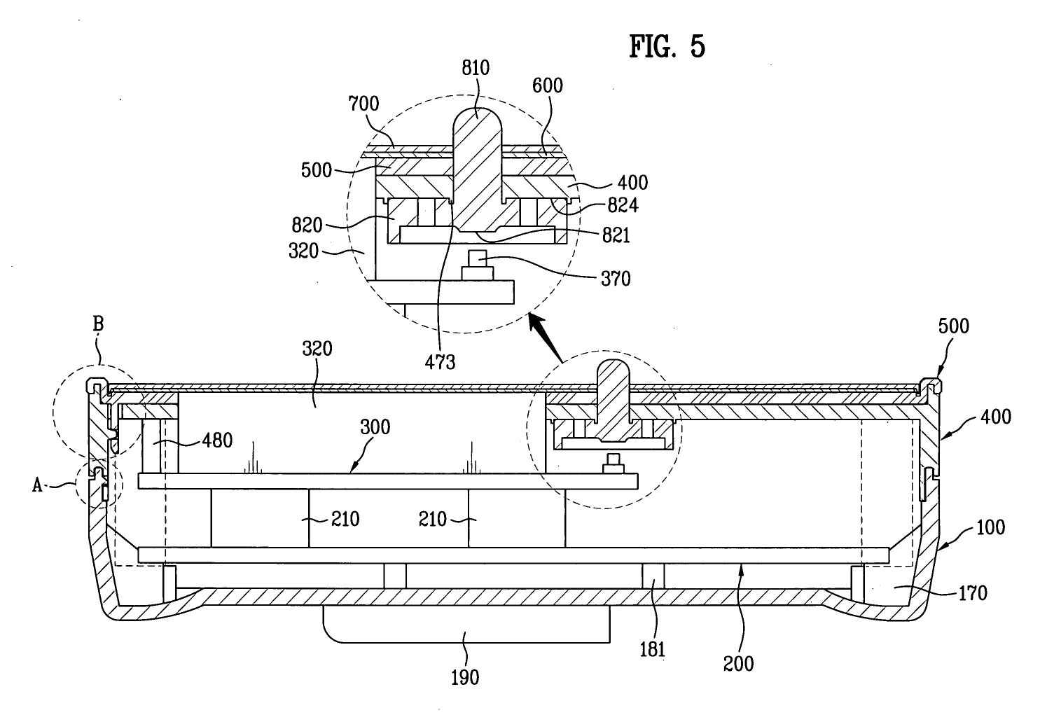

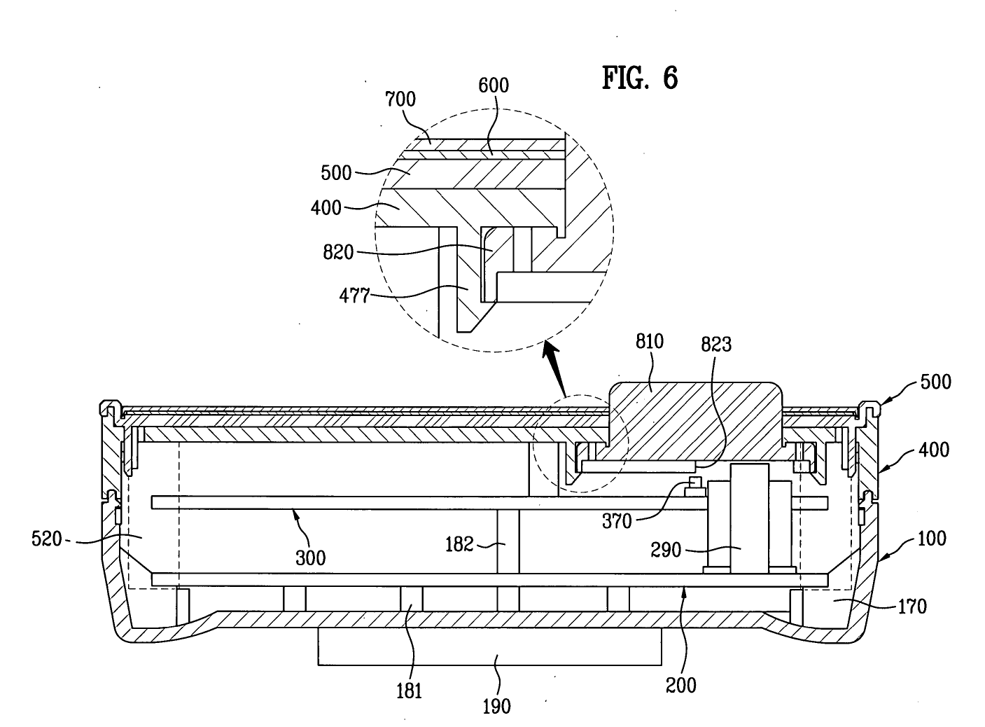

In the meantime, referring to FIGS. 5 and 6, the outer case 500 has a see-through sheet 600 of resin, such as PET (polyethylene terephthalate) on an upper surface, which is an exposed surface, for looking through the display window 510.

On an upper surface of the see-through sheet 600, there is a protective sheet 700 of a light metal, such as aluminum, having a see-through window 710 in correspondence to the display window 510 of the outer case 500.

The see-through sheet 600, and the protective sheet 700 have sizes in conformity with a size of the upper surface of the outer case 500.

Of course, the see-through sheet 600 may have a size corresponding to a size of the display window 510 of the outer case 500, and the protective sheet 700 may have a size corresponding to the upper surface of the outer case 500.

In this instance, referring to FIG. 8, the outer case 500 has an interference preventive groove 502 in a periphery of the upper surface, for preventing the protective sheet 700 from coming off the upper surface due to interference with a possible burr 702 from a fabrication process (for an example, cutting with a press) of the protective sheet 700.

Moreover, it is preferable that the periphery of the outer case 500 is plated with, such as chrome, for preventing corrosion, wear, and maintaining the periphery glossy.

In the meantime, referring to FIGS. 5 and 6, a structure in which the communication modem board 200 and the display board 300 are held inside of the upper and lower cases 400, and 100 will be described in more detail.

The communication modem board 200 and the display board 300 are mounted inside of the upper, and lower cases 400, and 100 in a state the communication modem board 200 and the display board 300 are coupled together.

The lower case 100 has “L” shaped guide ribs 170 (see FIG. 3) on an edge of an upper surface, which is unexposed, for placing the communication modem board 200 at a position spaced a predetermined height from the upper surface of the lower case 100, and preventing the communication modem board 200 from shaking.

There are a plurality of guide ribs 170 along the edge of the upper surface of the lower case 100 at predetermined intervals.

The lower case 100 has a plurality of lower supporting bosses 181 on the upper surface for supporting the communication modem board 200.

The lower supporting bosses 181 are mostly distributed at a position opposite to a central region of the communication modem board 200, and each has a flat projection end, for close contact with an underside surface of the communication modem board 200.

Moreover, it is preferable that the lower supporting bosses 181 are distributed concentrated opposite to a region around a tact switch 370, for preventing the communication modem board 200 from being pressed down to one side as the tact switch 370 on the display board 300 over the communication modem board 200 is pressed.

Along with this, the lower case 100 has a supporting pin 182 on the upper surface for direct supporting of the display board 300 for preventing the display board 300 itself from tilting as the switch 370 on the display board 300 is pressed.

That is, the supporting pin 182 is passed through a hole in the communication modem board 200, and has an end surface in close contact with the underside of the display board 300.

In this instance, it is preferable that the supporting pin 182 has a flat end, and is formed opposite to a region around the switch 370 of the display board 300.

Along with the lower supporting bosses 181 for supporting the communication modem board 200, the upper case 400 has a plurality of upper supporting bosses 480 (see FIG. 4) on a lower surface, which is unexposed surface, for supporting the display board 300.

The upper supporting bosses 480 have flat projection ends for making close contact with, and supporting the upper surface of the display board 300, and are mostly distributed at a position corresponding to a periphery region of the display board 300.

That is, it is preferable that the upper supporting bosses 480 are formed around the window 410 of the upper case 400, a position opposite to the upper surface of around the LCD segment 320 of the display board 300.

In the meantime, there is an operation button 800 for pressing down the tact switch 370 on the display board 300 from an outside of the remote monitor.

That is, referring to FIG. 3, the upper case 400 has a button hole 470 for placing the operation button 800 therein, and the outer case 500 has a communication hole 570 in correspondence to the button hole 470.

Moreover, the see-through sheet 600 and the protective sheet 700 have matched holes 670, and 770 matched to the communication hole 570.

Accordingly, the operation button 800, mounted such that a portion thereof is exposed through the button hole 470, the communication hole 570 and the matched holes 670, and 770, is configured to presses the tact switch 370 as the operation button 1800 is pressed from an outside, and return to an original position, again.

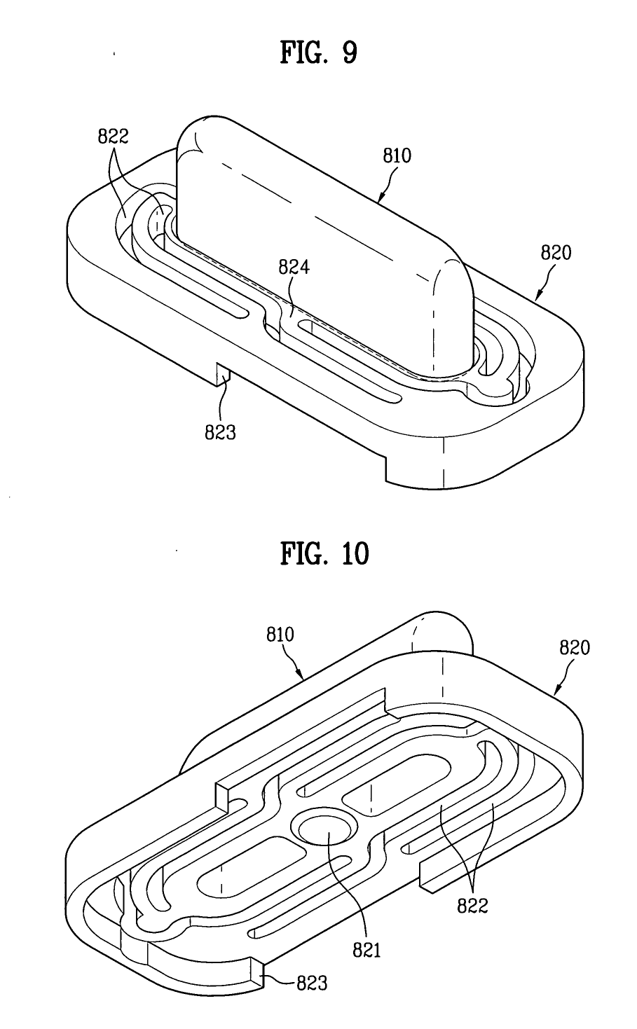

Referring to FIGS. 9 and 10, the operation button 800 includes a pressing portion 810 exposed to an outside of the remote monitor for enabling operation through the button hole 470 and the communication hole 570 in the upper case 400, and a mounting portion 820 formed as one body with the pressing portion 810 at a lower portion for being held at an underside of the upper case 400.

There are hooks 477 projected from the underside of the upper case 400 at opposite sides of the button hole 470, so that the operation button 800 is secured to the upper case 400 as the operation button 800 has bottom edges of the mounting portion 820 hooked at the hooks 477 (see FIG. 6).

The mounting portion 820 has a contact projection 821 at a central portion for being brought into contact with the tact switch 370 when the operation button 800 is pressed.

Moreover, the mounting portion 820 has elastic ribs 822 of a plurality of slots on a periphery for providing restoring force to the operation button 800.

Furthermore, the mounting portion 820 has an interference avoidance slot 823 at a bottom circumference for preventing the operation button 800 from interfering with an electronic component 290 (see FIG. 6) on the communication modem board 200 in the vicinity of the tact switch 370 at the time of mounting the operation button 800.

Since the operation button 800 is symmetry in both directions, it is preferable that the interference avoidance slots 823 are formed at opposite sides of the circumference of the mounting portion 820 symmetrically, for preventing the operation button 800 from interfering with the electronic component even if the operation button 800 is mounted in an opposite direction by mistake.

In the meantime, the upper case 400 has a downward stepped portion 473 (see FIG. 5) around the button hole 470, and the mounting portion 820 of the operation button 800 has a counter stepped portion 824 (see FIG. 5) projected opposite to the stepped portion such that the counter stepped portion 824 is in close contact with an underside of the upper case 400 when the operation button 800 is mounted.

It is preferable that the counter stepped portion 824 has a projected length the same with a projected length of the stepped portion 473, so that the counter stepped portion 824 is brought into close contact with the underside of the upper case 400 when the operation button 800 is mounted.

Accordingly, when the operation button 800 is mounted in the button hole 470 of the upper case 400, since the counter stepped portion 824 of the operation button 800 is brought into close contact with the under side of the upper case 400 while surrounding the stepped portion 473 of the upper case 400, the counter stepped portion 824 can prevent infiltration of water through the button hole 470.

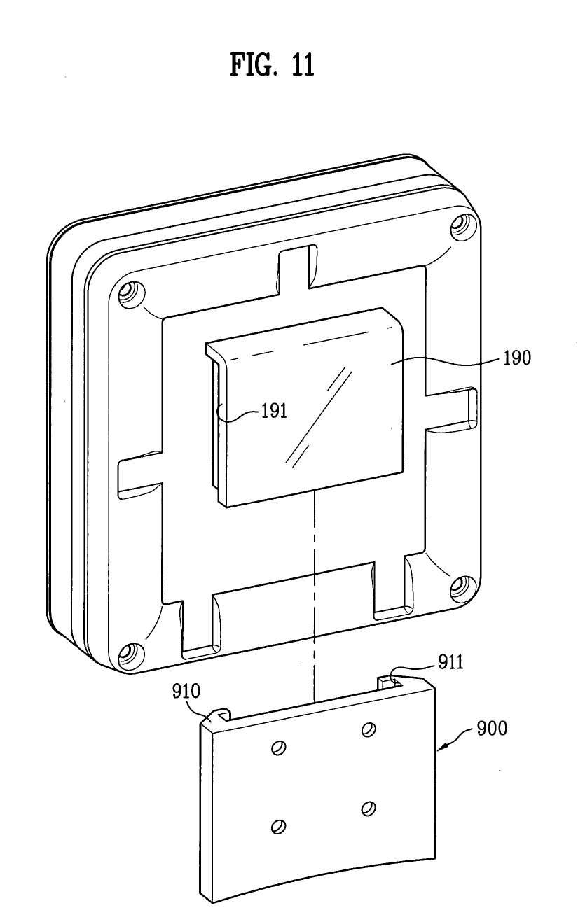

In the meantime, referring to FIG. 11, the remote monitor 1 can be mounted on a user's desired place by means of separate securing means.

That is, the remote monitor 1 may be mounted on a wall or the like of a living room where the user stays most of the time.

The securing means includes a substantially rectangular mounting portion 190 projected from a central portion of a bottom which is an exposed side of the lower case 100 of the remote monitor 1, and a hanger 900 to be fixedly secured to the wall the remote monitor 1 is to be mounted thereon for placing the mounting portion 190 thereon.

The mounting portion 190 has guide projections 191 on opposite sides, and the hanger 900 has seating portions 910 on opposite sides, each having a guide groove in an inside for slidably placing the guide projections 191 therein.

Therefore, the remote monitor 1 can be mounted readily, if the guide projections 191 on the mounting portion 190 of the lower case 100 are slidably placed in the guide grooves 911 on the seating portions 910 of the hanger 900 after the hanger 900 is fixedly secured to the wall with fastening members, such as bolts.

In this instance, in light of a fine view, it is preferable that a size of the hanger 900 is smaller than a size of the lower case 100 so that the hanger 900 is invisible when the remote monitor 1 is seen from a front.

In the meantime, referring to FIG. 3, the outer case 500 has shrinkage preventive grooves 501 in an upper surface which is an exposed surface of the outer case, for preventing the fastening bosses 520 from shrinking at the time of injection molding by using a mold.

The shrinkage preventive grooves 501 are formed in corners of the upper surface of the upper case 500 where the fastening bosses 520 are, each in a shape of a ring having an axis the same with a longitudinal axis of the fastening boss 520.

According to this, the outer case 500 can substantially spread shrinking force acting on the fastening boss 520 at the time of injection molding with a mold to the shrinkage preventive groove 501, for preventing the fastening boss 520 from shrinking in advance.

The lower case 100 has slide portions 101 at the upper surface which is an unexposed surface of the lower case 100, for removing a mold without interference with the hooks 133 on the lower case 100 at the time of injection molding of the lower case 100 with the mold.

The slide portion 101 is a flat portion extended from an edge of the upper surface of the lower case 100 to a circumference of the lower case 100 under the hook 133.

Of course, a number of the slide portion 101 is the same with a number of the hooks 133.

The slide portions 101 of the lower case 100 enable smooth upward removal of the mold without interference with the hooks 133 after the mold is moved to a central side of the lower case 100 through the slide portions 101.

In the meantime, though not shown, the remote monitor 1 may be provided with a speaker for remote display as well as announcing a state of progress of a home appliance with a sound.

That is, if a sound designated for a state of progress of the home appliance is provided through the speaker, the user can notice the state of progress and an error state only with the sound, enabling the user to make an appropriate maintenance and control of the home appliance.

A process for assembling the remote monitor 1 will be described with reference to FIGS. 3 to 10.

Referring to FIG. 3, the male terminal pin 310 of the display board 300 is placed in the female terminal pin 210 of the communication modem board 200, to mount, and electrically connect the display board 300 onto the communication modem board 200.

The mounting of the display board 300 on the communication modem board 200 in a fashion of stacking enables to minimize mounting spaces of the communication modem board 200 and the display board 300, thereby enabling to make a size of the remote monitor 1 smaller.

Then, a control board having the display board 300 mounted on the communication modem board 200 is placed on the guide ribs 170 of the lower case 100.

The guide ribs 170, substantially in “L” shapes in conformity with the circumference of the communication modem board 200, enables mounting of the control board in an inside space of the lower case 100 at a predetermined height, and preventing the control board from shaking.

In the meantime, referring to FIG. 4, the operation button 800 is placed in the button hole 470 in the upper case 400, wherein the operation button 800 is held in the button hole 470 firmly by the hooks 477 on the upper case 400.

In this instance, referring to FIG. 5, the stepped portion 473 on the button hole 470 of the upper case 400 and the counter stepped portion 824 on the operation button 800, which is in close contact with the underside of the upper case 400 while surrounding the stepped portion 473, prevent infiltration of water through the button hole 470.

Moreover, referring to FIG. 6, the operation button 800 has the interference avoidance slot 823 for preventing the operation button 800 from interfering with various electronic components of the control board in the lower case.

Therefore, the upper case 400 can be mounted on the lower case 100 smoothly without interference between the operation button 800 and the various electronic components 290 on the control board in the lower case 100.

In the meantime, the see-through sheet 600 and the protective sheet 700 on the upper surface of the upper case 400 are attached thereto with two side tapes, or adhesive.

The interference preventive groove 502 in the periphery of the upper surface of the outer case 500, formed to prevent interference with burrs 702 (see FIG. 8) left in a fabrication process of the protective sheet 700, prevents the protective sheet 700 from coming off the upper surface of the outer case 500 in advance.

Thereafter, the upper case 400, and the outer case 500 are positioned on the lower case 100 in succession, and secured thereto, which will be described in more detail.

At first, the upper case 400 is coupled to the lower case 100 by placing the upper rim 130 (see FIG. 7) of the lower case 100 in the lower groove 430 (see FIG. 7) of the upper case 400.

Then, the hooks 131 on the inside surface of the upper rim 130 are held at the hook holes 431 in the lower groove 430, to couple the upper case 400 to the lower case 100, firmly.

The sealing portions 430a in the lower groove 430 where end edges of the upper rim 130 are to be pressed down thereon prevent infiltration of water through circumferences of the upper case 400 and the lower case 100, which come into contact when the upper case 400 and the lower case 100 are coupled.

In the meantime, an upper surface of the LCD segment 320 (see FIG. 5) on the display board 300 is exposed to an outside matched to the window 410 in the upper case 400.

Next, referring to FIG. 4, the outer case 500 is coupled to an upper side of the upper case 400 as the upper rim 450 of the upper case 400 is placed in the lower groove 550 in the outer case 500.

At the same time with this, the holding portions 560 on the outer case 500 pass through the slots 460 in the upper case 400, and the hook holes 561 in the holding portions 560 are engaged with the hooks 461 on the upper case 400, thereby coupling the outer case 500 to the upper case 400, firmly.

In this instance, referring to FIG. 5, the upper surface of the LCD segment 320 exposed through the window 410 of the upper case 400 is exposed through the display window 510 of the outer case 500 through the see-through sheet 600 on the outer case 500.

Moreover, the outer case 500 has the communication hole 570 in communication with the button hole 470, wherein the operation button 800 is made operable as the operation button 800 is projected outwardly through the button hole 470 and the communication hole 570.

In the meantime, referring to FIG. 3, the lower case 100, the upper case 400, and the outer case 500 are coupled together thus, and fastened with fastening screws ‘S’ in a state the fastening bosses 520 are passed through the pass through holes 420 in the upper case 400 and in contact with the fastening holes 120 in the lower case 100.

According to this, steps between the cases 100, 400, and 500 required for assembly of the cases 100, 400, and 500 can be minimized, and the cases 100, 400, and 500 can be assembled at a time, easily.

In the meantime, referring to FIGS. 5 and 6, the communication modem board 200 and the display board 30 are supported on the upper, and lower supporting bosses 181 within the upper and lower cases 400, and 100 firmly.

That is, the display board 300 is supported by the upper supporting bosses 480 on the upper case 400, and the communication modem board 200 is supported on the lower supporting bosses 181 on the lower case 100.

Moreover, the lower case 100 also has the supporting pin 182 for passing through the communication modem board 200 and supporting the display board 300.

Therefore, even if the switch 370 on the display board 300 is pressed down through the operation button 800, the supporting pin 182 prevents the display board 300 from tilting in advance.

A mounting process of the remote monitor 1 assembled thus will be described with reference to FIG. 11.

In order to mount the remote monitor 1, the hanger 900 is fixedly secured to a wall of a place the user desires with fastening members, such as bolts.

Then, upon slidably placing the guide projections 191 on the mounting portions 190 of the remote monitor 1 in the guide grooves 911 in the seating portions 910 of the hanger 900 in an up/down direction, the remote monitor 1 is held at the wall of the place the user desires by the hanger 900.

In this instance, since the hanger 900 has a size smaller than a whole size of the remote monitor 1, the hanger 900 is invisible when the user looks at the remote monitor 1, and the outer case 500 of the remote monitor 1 has fine view with the chrome plating on the periphery for preventing scratching, wearing down, and so on.

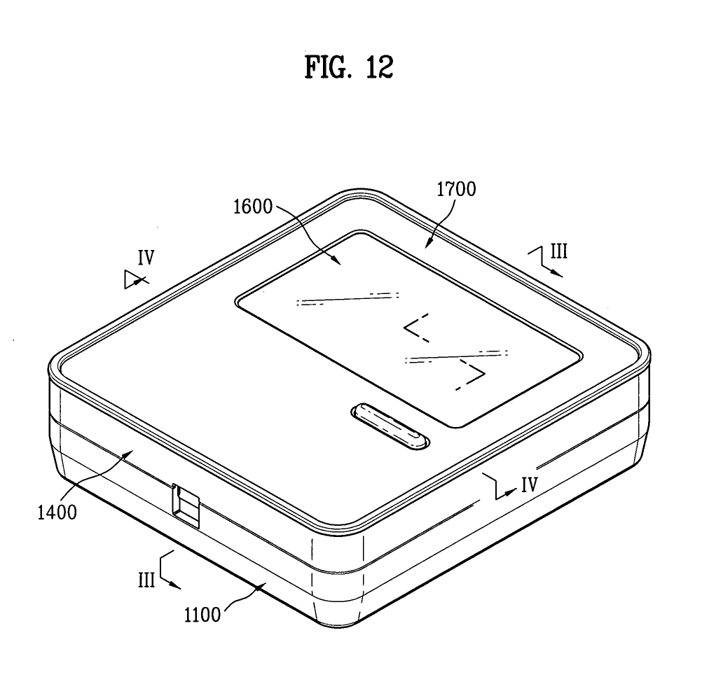

A remote monitor in accordance with a second preferred embodiment of the present invention will be described with reference to FIGS. 12 to 21.

Referring to FIG. 12, the remote monitor 10 includes an upper case 1400 which also can function as the outer case 500 (see FIG. 3) of the remote monitor 1 (see FIG. 1) of the first embodiment.

The remote monitor 10 is also connected to home appliances, such as the washing machine 2 (see FIG. 1) and a dryer 3 (see FIG. 1), with power line for transmission/reception of data by a power line communication system.

The remote monitor 10 will be described in more detail.

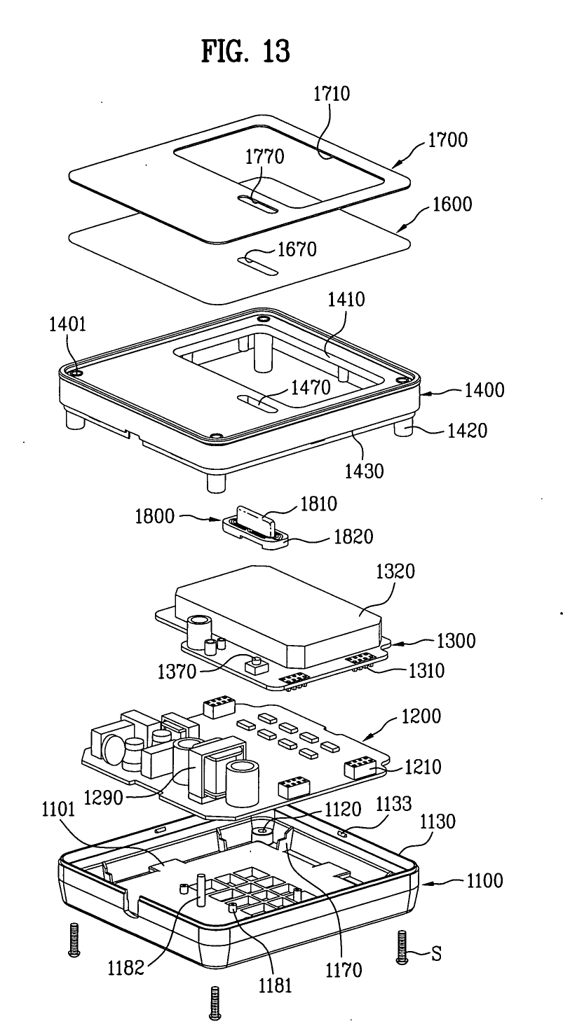

Referring to FIG. 13, the remote monitor 10 includes a lower case 1100, a control board mounted on the lower case 1100, having a communication modem board 1200 and a display board 1300, and an upper case 1400 on the lower case 1100.

The lower case 1100 is substantially rectangular, with an opened top to form a space therein, and the upper case 1400 is substantially rectangular, with an opened bottom to form a space therein, and detachably coupled to an upper side of the lower case 1100.

The communication modem board 1200 is placed in an inside space of the lower case 1100, and the display board 1300 is mounted on the communication modem board 1200, fixedly, or detachably.

The display board 1300 has male terminal pins 1310 at opposite edges, and the communication modem board 1200 has female terminal pins 1210 at opposite edges, wherein the display board 1300 is electrically connected to, or disconnected from an upper side of the communication modem board 1200 as male terminal pins 310 at opposite edges of the display board 1300 are connected to, or disconnected from female terminal pins 1210 at opposite edges of the communication modem board 1200, respectively.

Of course, the display board 1300 may have female terminal pins, and the communication modem board 1200 may have male terminal pins, for the display board 1300 to be electrically connected to, or disconnected from the upper side of the communication modem board 1200.

The upper case 1400 has a window 1410 for showing an LCD segment 320, which is a display portion of the display board 1300, and is detachably secured to the upper side of the lower case 1100.

In this instance, the LCD segment 1320 is detachably fastened to the display board 1300 by a screw fastening system, or a hook fastening system, for displaying state information, such as a course progress, a cycle time period, and so on of the home appliance with numerals, characters, and so on.

Structures of the upper case 1400, and the lower case 1100 will be described in more detail.

The upper case 1400 has downward fastening bosses 1420 at corners of a bottom surface which is a non-exposed surface, and the lower case 1100 has fastening holes 1120 in upward projections toward an upper side thereof which is a non-exposed surface.

Accordingly, the upper case 1400, and the lower case 1100 are assembled at a time, as screws ‘S’, fastening members, are fastened to the fastening bosses 1420 through the fastening holes 1120 while forming threads respectively in a state the fastening bosses 1420 are in contact with the fastening holes 1120, respectively.

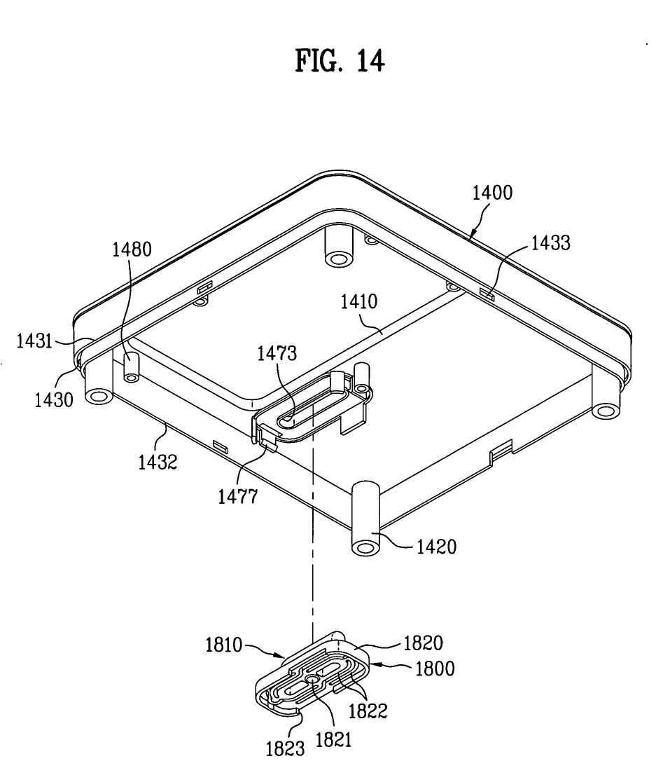

In the meantime, the lower case 1100 has an upper rim 1130 along an upper side circumference, and the upper case 1400 has a lower groove 1430 (see FIG. 14) along a lower side circumference to be engaged with the upper rim 1130.

Of course, the upper case 1400 may have a lower rim along a lower side circumference, and the lower case 1100 may have an upper groove along an upper side circumference.

As the lower groove 1430 is formed at a lower side circumference of the upper case 1400, the upper case 1400 becomes to have double shelled, with an outer rim 1431 (see FIG. 14) on an outer side of the lower groove 1130, and an inner rim 1432 (see FIG. 14) on an inner side of the lower groove 1130.

The inner rim 1432 is projected longer than the outer rim 1431, for enhancing a close contact capability of an inner side of the upper rim 1130 with the inner rim 432, so that the upper case 1400 and the lower case 1100 are coupled more firmly for protection of infiltration of water.

The lower groove 1430 of the upper case 1400 has a sealing portion 1430a (see FIG. 17) where opposite edges of an end of the upper rim 1130 are pressed down at the time the lower groove 1430 is engaged with the upper rim 1130.

The sealing portion 1430a has sloped surfaces for pressing down the opposite edges of the end of the upper rim 1130 thereon, respectively.

Moreover, the lower case 1100 has a plurality of hooks 1133 (see FIG. 17) at regular intervals along an inner side surface of the upper rim 1130, and the upper case 1400 has a plurality of hook holes 1433 (see FIG. 17) in the inner rim 1432 at positions matched to the plurality of hooks 1133 for engagement with the plurality of hooks 1133.

Therefore, if the upper rim 1130 of the lower case 1100 is engaged with the lower groove 1430 of the upper case 1400, the hooks 1133 on the lower case 1100 are engaged with the hook holes 1433 in the upper case 1400, thereby making the upper, and lower case coupled, firmly.

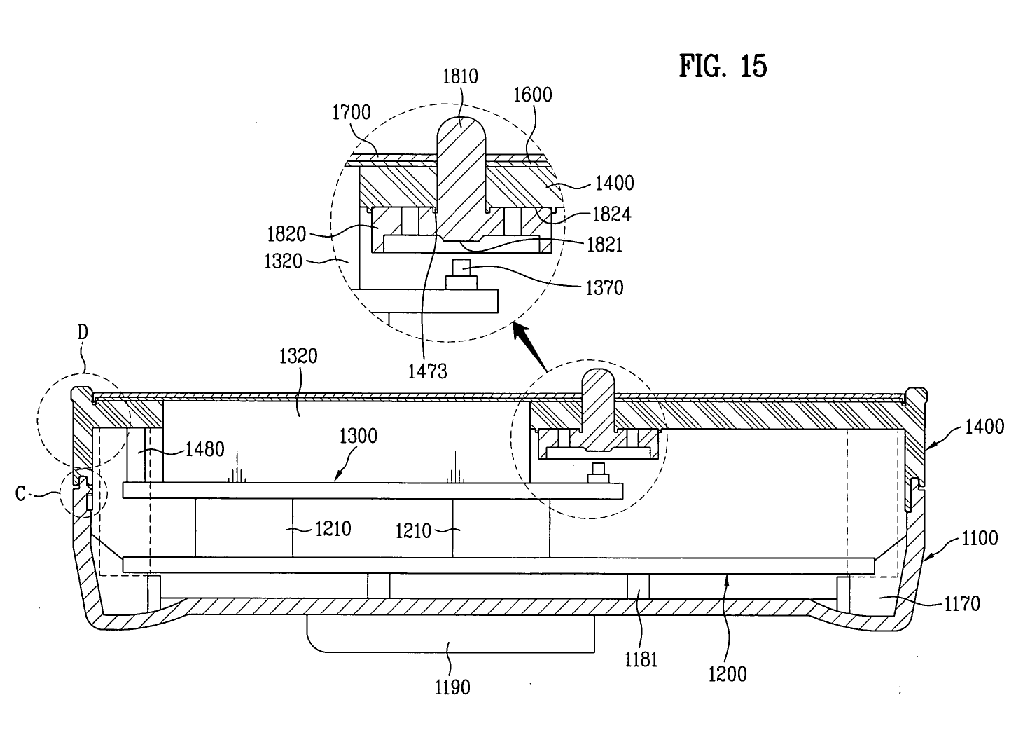

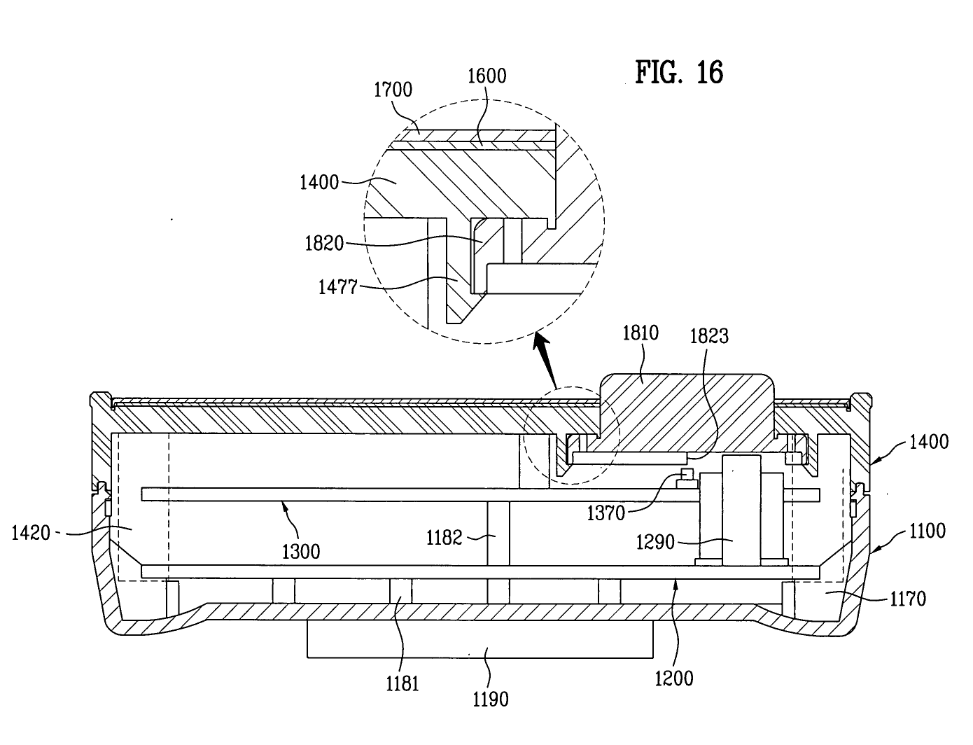

In the meantime, referring to FIGS. 15 and 16, the upper case 1400 has a see-through sheet 1600 of resin, such as PET (polyethylene terephthalate) on an upper surface, which is an exposed surface, for looking through the window 1410.

On an upper surface of the see-through sheet 1600, there is a protective sheet 1700 of a light metal, such as aluminum, having a see-through window 1710 in correspondence to the window 1410 of the upper case 1400.

The see-through sheet 1600, and the protective sheet 1700 have sizes in conformity with a size of the upper surface of the upper case 1400.

Of course, the see-through sheet 1600 may have a size corresponding to a size of the window 1410 of the upper case 1400, and the protective sheet 1700 may have a size corresponding to the upper surface of the upper case 1400.

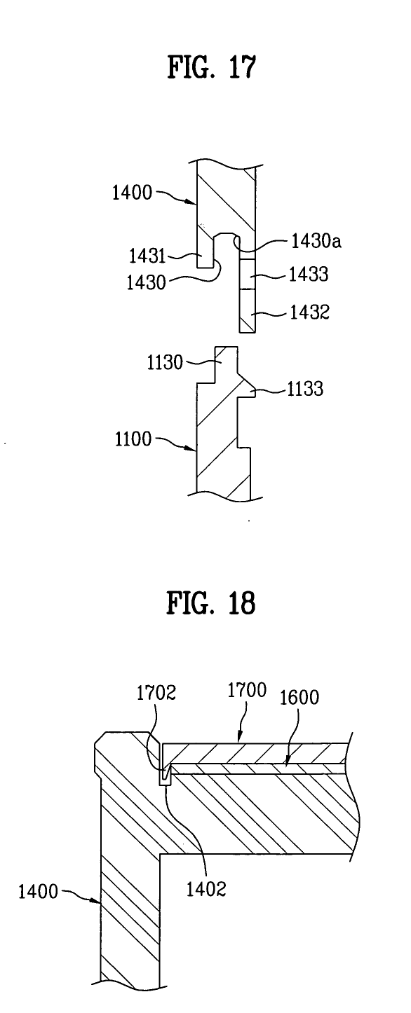

In this instance, referring to FIG. 18, the upper case 1400 has an interference preventive groove 1402 in a periphery of the upper surface, for preventing the protective sheet 1700 from coming off the upper surface due to interference with a possible burr 1702 from a fabrication process (for an example, cutting with a press) of the protective sheet 1700.

Moreover, it is preferable that the periphery of the upper surface of the upper case 1400 is plated with, such as chrome, for preventing corrosion, wear, and maintaining the periphery glossy.

In the meantime, referring to FIGS. 15 and 16, a structure in which the communication modem board 1200 and the display board 1300 are held inside of the upper and lower cases 1400, and 1100 will be described in more detail.

The communication modem board 1200 and the display board 1300 are mounted inside of the upper, and lower cases 1400, and 1100 in a state the communication modem board 1200 and the display board 1300 are coupled together.

The lower case 1100 has “L” shaped guide ribs 1170 (see FIG. 13) on an edge of an upper surface, which is unexposed, for placing the communication modem board 1200 at a position spaced a predetermined height from the upper surface of the lower case 1100, and preventing the communication modem board 1200 from shaking.

There are a plurality of guide ribs 1170 along the edge of the upper surface of the lower case 1100 at predetermined intervals.

The lower case 1100 has a plurality of lower supporting bosses 1181 on the upper surface for supporting the communication modem board 1200.

The lower supporting bosses 1181 are mostly distributed at a position opposite to a central region of the communication modem board 1200, and each has a flat projection end, for close contact with an underside surface of the communication modem board 1200.

Moreover, it is preferable that the lower supporting bosses 1181 are distributed concentrated opposite to a region around a tact switch 1370, for preventing the communication modem board 1200 from being pressed down to one side as the tact switch 1370 on the display board 1300 over the communication modem board 1200 is pressed.

Along with this, the lower case 1100 has a supporting pin 1182 on the upper surface for direct supporting of the display board 1300 for preventing the display board 1300 itself from tilting as the switch 1370 on the display board 1300 is pressed.

That is, the supporting pin 1182 is passed through a hole in the communication modem board 1200, and has an end surface in close contact with the underside of the display board 1300.

In this instance, it is preferable that the supporting pin 1182 has a flat end, and is formed opposite to a region around the switch 1370 of the display board 1300.

Along with the lower supporting bosses 1181 for supporting the communication modem board 1200, the upper case 1400 has a plurality of upper supporting bosses 1480 (see FIG. 14) on a lower surface, which is unexposed surface, for supporting the display board 1300.

The upper supporting bosses 1480 have flat projection ends for making close contact with, and supporting the upper surface of the display board 1300, and are mostly distributed at a position corresponding to a periphery region of the display board 1300.

That is, it is preferable that the upper supporting bosses 1480 are formed around the window 1410 of the upper case 1400, a position opposite to the upper surface of around the LCD segment 1320 of the display board 1300.

In the meantime, there is an operation button 1800 for pressing down the tact switch 1370 on the display board 300 from an outside of the remote monitor.

That is, referring to FIG. 13, the upper case 1400 has a button hole 1470 for placing the operation button 1800 therein.

Moreover, the see-through sheet 1600 and the protective sheet 1700 have matched holes 1670, and 1770 matched to the button hole 1470.

Accordingly, the operation button 1800, mounted such that a portion thereof is exposed through the button hole 1470, and the matched holes 1670, and 1770, is configured to presses the tact switch 1370 as the operation button 1800 is pressed from an outside, and return to an original position, again.

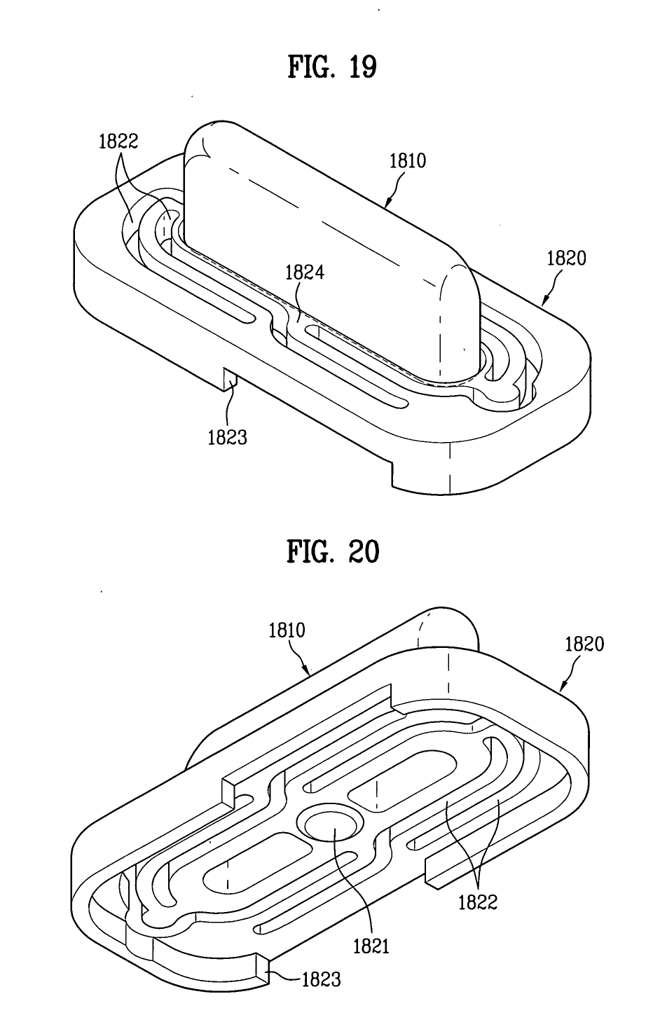

Referring to FIGS. 19 and 20, the operation button 1800 includes a pressing portion 1810 exposed to an outside of the remote monitor for enabling operation through the button hole 1470 in the upper case 1400, and a mounting portion 1820 formed as one body with the pressing portion 1810 at a lower portion for being held at an underside of the upper case 1400.

There are hooks 1477 projected from the underside of the upper case 1400 at opposite sides of the button hole 1470, so that the operation button 1800 is secured to the upper case 1400 as the operation button 1800 has bottom edges of the mounting portion 1820 hooked at the hooks 1477 (see FIG. 16).

The mounting portion 1820 has a contact projection 1821 at a central portion for being brought into contact with the tact switch 1370 when the operation button 1800 is pressed.

Moreover, the mounting portion 1820 has elastic ribs 1822 of a plurality of slots on a periphery for providing restoring force to the operation button 1800.

Furthermore, the mounting portion 1820 has an interference avoidance slot 1823 at a bottom circumference for preventing the operation button 1800 from interfering with an electronic component 1290 (see FIG. 16) on the communication modem board 1200 in the vicinity of the tact switch 1370 at the time of mounting the operation button 1800.

Since the operation button 1800 is symmetry in both directions, it is preferable that the interference avoidance slots 1823 are formed at opposite sides of the circumference of the mounting portion 1820 symmetrically, for preventing the operation button 1800 from interfering with the electronic component even if the operation button 1800 is mounted in an opposite direction by mistake.

In the meantime, the upper case 1400 has a downward stepped portion 473 (see FIG. 15) around the button hole 1470, and the mounting portion 1820 of the operation button 1800 has a counter stepped portion 1824 (see FIG. 15) projected opposite to the stepped portion such that the counter stepped portion 1824 is in close contact with an underside of the upper case 1400 when the operation button 1800 is mounted.

It is preferable that the counter stepped portion 1824 has a projected length the same with a projected length of the stepped portion 1473, so that the counter stepped portion 1824 is brought into close contact with the underside of the upper case 1400 when the operation button 1800 is mounted.

Accordingly, when the operation button 1800 is mounted in the button hole 1470 of the upper case 1400, since the counter stepped portion 1824 of the operation button 1800 is brought into close contact with the under side of the upper case 1400 while surrounding the stepped portion 1473 of the upper case 1400, the counter stepped portion 1824 can prevent infiltration of water through the button hole 1470.

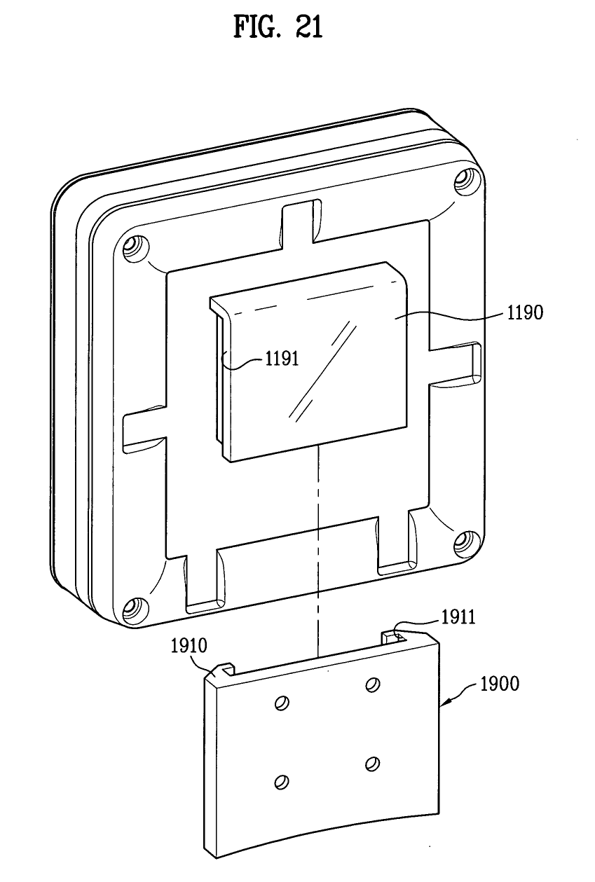

In the meantime, referring to FIG. 21, the remote monitor 10 can be mounted on a user's desired place by means of separate securing means.

That is, the remote monitor 10 may be mounted on a wall or the like of a living room where the user stays most of the time.

The securing means includes a substantially rectangular mounting portion 1190 projected from a central portion of a bottom which is an exposed side of the lower case 1100 of the remote monitor 10, and a hanger 1900 to be fixedly secured to the wall the remote monitor 10 is to be mounted thereon for placing the mounting portion 1190 thereon.

The mounting portion 1190 has guide projections 1191 on opposite sides, and the hanger 1900 has seating portions 1910 on opposite sides, each having a guide groove in an inside for slidably placing the guide projections 1191 therein.

Therefore, the remote monitor 10 can be mounted readily, if the guide projections 1191 on the mounting portion 1190 of the lower case 1100 are slidably placed in the guide grooves 1911 on the seating portions 1910 of the hanger 1900 after the hanger 1900 is fixedly secured to the wall with fastening members, such as bolts.

In this instance, in light of a fine view, it is preferable that a size of the hanger 1900 is smaller than a size of the lower case 1100 so that the hanger 1900 is invisible when the remote monitor 10 is seen from a front.

In the meantime, referring to FIG. 13, the upper case 1400 has shrinkage preventive grooves 1401 in an upper surface which is an exposed surface of the upper case, for preventing the fastening bosses 1420 from shrinking at the time of injection molding by using a mold.

The shrinkage preventive grooves 1401 are formed in corners of the upper surface of the upper case 1400 where the fastening bosses 1420 are, each in a shape of a ring having an axis the same with a longitudinal axis of the fastening boss 1420.

According to this, the upper case 1400 can substantially spread shrinking force acting on the fastening boss 1420 at the time of injection molding with a mold to the shrinkage preventive groove 1401, for preventing the fastening boss 1420 from shrinking in advance.

The lower case 1100 has slide portions 1101 at the upper surface which is an unexposed surface of the lower case 1100, for removing a mold without interference with the hooks 1133 on the lower case 1100 at the time of injection molding of the lower case 1100 with the mold.

The slide portion 1101 is a flat portion extended from an edge of the upper surface of the lower case 1100 to a circumference of the lower case 1100 under the hook 1133.

Of course, a number of the slide portion 1101 is the same with a number of the hooks 1133.

The slide portions 1101 of the lower case 1100 enable smooth upward removal of the mold without interference with the hooks 1133 after the mold is moved to a central side of the lower case 1100 through the slide portions 1101.

In the meantime, though not shown, the remote monitor 10 may be provided with a speaker for remote display as well as announcing a state of progress of a home appliance with a sound.

That is, if a sound designated for a state of progress of the home appliance is provided through the speaker, the user can notice the state of progress and an error state only with the sound, enabling the user to make an appropriate maintenance and control of the home appliance.

A process for assembling the remote monitor 10 will be described with reference to FIGS. 13 to 20.

Referring to FIG. 13, the male terminal pin 1310 of the display board 1300 is placed in the female terminal pin 1210 of the communication modem board 1200, to mount, and electrically connect the display board 1300 onto the communication modem board 1200.

The mounting of the display board 1300 on the communication modem board 1200 in a fashion of stacking enables to minimize mounting spaces of the communication modem board 1200 and the display board 1300, thereby enabling to make a size of the remote monitor 10 smaller.

Then, a control board having the display board 1300 mounted on the communication modem board 1200 is placed on the guide ribs 1170 of the lower case 1100.

The guide ribs 1170, substantially in “L” shapes in conformity with the circumference of the communication modem board 1200, enable mounting of the control board in an inside space of the lower case 1100 at a predetermined height, and preventing the control board from shaking.

In the meantime, referring to FIG. 14, the operation button 1800 is placed in the button hole 1470 in the upper case 1400, wherein the operation button 1800 is held in the button hole 1470 firmly by the hooks 1477 on the upper case 1400.

In this instance, referring to FIG. 15, the stepped portion 1473 on the button hole 1470 of the upper case 1400 and the counter stepped portion 1824 on the operation button 1800, which is in close contact with the underside of the upper case 1400 while surrounding the stepped portion 1473, prevent infiltration of water through the button hole 1470.

Moreover, referring to FIG. 16, the operation button 1800 has the interference avoidance slot 1823 for preventing the operation button 1800 from interfering with various electronic components of the control board in the lower case.

Therefore, the upper case 1400 can be mounted on the lower case 100 smoothly without interference between the operation button 1800 and the various electronic components 1290 on the control board in the lower case 1100.

In the meantime, the see-through sheet 1600 and the protective sheet 1700 on the upper surface of the upper case 1400 are attached thereto with two sided tapes, or adhesive.

The interference preventive groove 1402 in the periphery of the upper surface of the upper case 1400, formed to prevent interference with burrs 1702 (see FIG. 8) left in a fabrication process of the protective sheet 1700, prevents the protective sheet 1700 from coming off the upper surface of the upper case 1400 in advance.

The upper case 400 having the operation button 1800, the see-through sheet 1600, and the protective sheet 1700 is coupled to the lower case 1100 by placing the upper rim 1130 (see FIG. 17) of the lower case 1100 in the lower groove 1430 (see FIG. 17) of the upper case 1400.

Then, the hooks 1131 on the inside surface of the upper rim 130 are held at the hook holes 1431 in the lower groove 1430, to couple the upper case 1400 to the lower case 1100, firmly.

The sealing portions 1430a in the lower groove 1430 where end edges of the upper rim 1130 are to be pressed down thereon prevent infiltration of water through circumferences of the upper case 1400 and the lower case 1100, which come into contact when the upper case 1400 and the lower case 1100 are coupled.

In the meantime, an upper surface of the LCD segment 1320 (see FIG. 15) on the display board 1300 is exposed to an outside matched to the window 1410 in the upper case 1400.

In this instance, referring to FIG. 15, the upper surface of the LCD segment 1320 exposed through the window 1410 of the upper case 1400 is exposed through the window 1410 through the see-through sheet 1600 on the upper case 1400.

Moreover, the upper case 1400 has the button hole 1470, wherein the operation button 1800 is made operable from an outside as the operation button 1800 is projected outwardly through the button hole 1470.

In the meantime, referring to FIG. 13, the lower case 1100, and the upper case 1400 are coupled together thus, and fastened with fastening screws ‘S’ in a state the fastening bosses 1420 of the upper case 1400 are in contact with the fastening holes 1120 in the lower case 1100.

According to this, steps between the cases 1100, and 1400 required for assembly of the cases 1100, and 1400 can be minimized, and the cases 100, and 1400 can be assembled at a time, easily.

In the meantime, referring to FIGS. 15 and 16, the communication modem board 1200 and the display modem board 130 are supported on the upper, and lower supporting bosses 1181 within the upper and lower cases 1400, and 1100, firmly.

That is, the display board 1300 is supported by the upper supporting bosses 1480 on the upper case 1400, and the communication modem board 1200 is supported on the lower supporting bosses 1181 on the lower case 1100.

Moreover, the lower case 1100 also has the supporting pin 1182 for passing through the communication modem board 1200 and supporting the display board 1300.

Therefore, even if the switch 1370 on the display board 1300 is pressed down through the operation button 1800, the supporting pin 1182 prevents the display board 1300 from tilting in advance.

A mounting process of the remote monitor 10 assembled thus will be described with reference to FIG. 21.

In order to mount the remote monitor 10, the hanger 1900 is fixedly secured to a wall of a place the user desires with fastening members, such as bolts.

Then, upon slidably placing the guide projections 1191 on the mounting portions 1190 of the remote monitor 10 in the guide grooves 1911 in the seating portions 1910 of the hanger 1900 in an up/down direction, the remote monitor 10 is held at the wall of the place the user desires by the hanger 1900.

In this instance, since the hanger 1900 has a size smaller than a whole size of the remote monitor 10, the hanger 1900 is invisible when the user looks at the remote monitor 10, and the upper case 1400 of the remote monitor 10 has fine view with the chrome plating on the periphery for preventing scratching, wearing down, and so on.

In the meantime, in the first, or second embodiment, instead of mounting the communication modem board 100, or 1200 in the remote monitor 1 or 10, an external type modem may be provided for transmission and reception of data through the modem of the home appliance and the power line, for having identical effects with the present invention.

That is, the display board 300, or 1300 in the remote monitor 1, or 10 may be connected to the external type modem with a communication line, for transmission and reception of data, so that the external type modem transmits/receives data to/from the modem of the home appliance, and the display board 300, or 1300 displays the data to an outside.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

### INDUSTRIAL APPLICABILITY

The remote monitor for a home appliance of the present invention has a distinctive industrial applicability in that user's easy and remote monitoring of a home appliance is permitted, enabling the user to take an appropriate measure at an appropriate time, thereby permitting effective maintenance and management of the home appliance, and effective management of things, such as laundry, used for the home appliance.

1. A remote monitor for a home appliance, the remote monitor being connected to at least one home appliance with a predetermined communication system for displaying, and controlling of a state of the home appliance at a place far from the home appliance, comprising:
a case forming an outside appearance of the remote monitor, including a lower case, and an upper case detachably mounted on an upper side of the lower case, the upper case having a window; and
a control board in the case, the control board having various electronic components mounted thereon.

2. The remote monitor as claimed in claim 1, wherein the control board includes;
a communication modem board for transmission/reception of data to/from the home appliance,
a display board mounted on the communication modem board fixedly, or detachably for displaying a state of the state of the home appliance to an outside.

3. The remote monitor as claimed in claim 2, wherein one of the communication modem board or the display board includes male terminal pins, and the other one includes female terminal pins opposite to the male terminal pins for placing in the female terminal pins.

4. The remote monitor as claimed in claim 2, further comprising at least one supporting pin passed through the communication modem board and supporting the display board.

5. The remote monitor as claimed in claim 2, wherein the display board includes;
an LCD segment fastened thereto with screws, or hooks for display of state information, such as a progress of operation and cycle error of the home appliance, to an outside with numerals or characters.

6. The remote monitor as claimed in claim 1, wherein the communication system is a power line communication system for transmission/reception of data through a power line.

7. The remote monitor as claimed in claim 1, wherein the upper case includes fastening bosses projected downward, and
the lower case includes fastening holes in correspondence to the fastening bosses,
wherein the upper case and the lower case are coupled at a time as fastening members are fastened to the fastening bosses through the fastening holes, respectively.

8. The remote monitor as claimed in claim 7, wherein the fastening bosses are formed at corners of a lower surface of the upper case, which is an unexposed surface.

9. The remote monitor as claimed in claim 7, wherein the fastening member is a fastening screw to be fastened to the fastening boss as the fastening screw is fastened to a hole in the fastening boss while forming a thread.

10. The remote monitor as claimed in claim 7, wherein the upper case includes a shrinkage preventive groove for preventing the fastening boss from shrinking at the time of injection molding with a mold.

11. The remote monitor as claimed in claim 10, wherein the shrinkage preventive grooves are formed in the upper surface which is an exposed surface of the upper case, each in a shape of a ring in correspondence to the fastening bosses.

12. The remote monitor as claimed in claim 1, further comprising a see-through sheet on an upper surface of the upper case, which is an exposed surface, for see-through an inside through the window, and a protective sheet on an upper surface of the see-through sheet having a see-through window in correspondence to the window on the upper case.

13. The remote monitor as claimed in claim 12, wherein the see-through sheet and the protective sheet have sizes in correspondence to the upper surface of the upper case, respectively.

14. The remote monitor as claimed in claim 12, wherein the see-through sheet is provided to be placed on the upper surface of the upper case, with a size corresponding to a size of the window on the upper case, and
the protective sheet has a size in correspondence to the upper surface of the upper case.

15. The remote monitor as claimed in claim 12, wherein the see-through sheet is formed of PET (polyethylene terephthalate).

16. The remote monitor as claimed in claim 12, wherein the protective sheet is formed of a light metal, such as aluminum.

17. The remote monitor as claimed in claim 12, wherein the upper case includes an interference preventive groove in the upper surface of the upper case for preventing interference of burrs left at an edge of the protective sheet.

18. The remote monitor as claimed in claim 1, wherein the upper case includes a button hole, with an operation button provided therein for being brought into contact with a switch on the control board as the operation button is pressed, and returning to an original position after being pressed.

19. The remote monitor as claimed in claim 18, wherein the operation button includes;
a pressing portion passed through the button hole and exposed to an outside of the upper surface of the upper case, and
a mounting portion formed as one body with the pressing portion at a lower portion for being held at an underside of the upper case around the button hole.

20. The remote monitor as claimed in claim 19, wherein the mounting portion includes elastic ribs of a plurality of slots for providing restoring force to the operation button.

21. The remote monitor as claimed in claim 19, wherein the mounting portion includes a contact projection on an underside to be in contact with a switch on the control board.

22. The remote monitor as claimed in claim 19, wherein the mounting portion is hooked to hooks on an underside of the upper case.

23. The remote monitor as claimed in claim 19, wherein the mounting portion includes an interference avoidance slot at a circumference for preventing the operation button from interfering with an electronic component on the control board.

24. The remote monitor as claimed in claim 23, wherein the interference avoidance slot is formed at a portion of the circumference where the mounting portion interferes with the electronic component on the control board on both sides of the circumference symmetrically.

25. The remote monitor as claimed in claim 18, wherein the upper case includes a downward stepped portion around the button hole, and the mounting portion of the operation button includes a counter stepped portion projected opposite to the stepped portion such that the counter stepped portion is in close contact with an underside of the upper case.

26. The remote monitor as claimed in claim 25, wherein the stepped portion and the counter stepped portion have identical lengths.

27. The remote monitor as claimed in claim 1, wherein one of the upper case and the lower case includes a rim, and the other one includes a groove in conformity with the rim.

28. The remote monitor as claimed in claim 27, wherein the rim and groove are formed along, and throughout opposite upper and lower circumferences.

29. The remote monitor as claimed in claim 27, wherein the circumference of the case having the groove has double circumferences with an inner circumference positioned on an inner side of the groove and an outer circumference positioned on an outer side of the groove.

30. The remote monitor as claimed in claim 29, wherein the inner circumference and the outer circumference have projection lengths different from each other.

31. The remote monitor as claimed in claim 30, wherein the inner circumference has the projection length longer than the projection length of the outer circumference.

32. The remote monitor as claimed in claim 27, wherein the groove includes a sealing portion where edges of an end of the rim are pressed down thereon when the groove is engaged with the projection.

33. The remote monitor as claimed in claim 32, wherein the sealing portion is sloped surfaces which are to be pressed down by the edges of the rim.

34. The remote monitor as claimed in claim 1, wherein one of the upper case and the lower case includes hooks and the other one includes hook holes in conformity with the hooks.

35. The remote monitor as claimed in claim 34, wherein the lower case includes slide portions at the upper surface which is an unexposed surface of the lower case, for removing a mold without interference with the hooks at the time of injection molding of the lower case with the mold.

36. The remote monitor as claimed in claim 35, wherein the slide portion is a flat portion extended from an edge of the upper surface of the lower case to a circumference of the lower case under the hook.

37. The remote monitor as claimed in claim 1, wherein the lower case includes guide ribs for placing the control board at a position spaced a predetermined height from the upper surface of the lower case, and preventing the control board from shaking.

38. The remote monitor as claimed in claim 36, wherein the guide rib has an “L” shaped substantially.

39. The remote monitor as claimed in claim 1, wherein the upper case includes at least one upper supporting boss projected therefrom for supporting the control board.

40. The remote monitor as claimed in claim 1, wherein the lower case includes at least one lower supporting boss projected therefrom for supporting the control board.

41. The remote monitor as claimed in claim 1, further comprising securing means for securing the case to a wall at a place far from the home appliance.

42. The remote monitor as claimed in claim 41, wherein the securing means includes;
a mounting portion projected outward from a bottom of the lower case which is an exposed side of the lower case, and
a hanger to be fixedly secured to the wall far from the home appliance for placing the mounting portion thereon.

43. The remote monitor as claimed in claim 42, wherein one of the mounting portion and the hanger includes guide projections, and the other one includes a seating portion having guide grooves for slidably placing the guide projections therein, respectively.

44. The remote monitor as claimed in claim 42, wherein the hanger has a size smaller than a size of the lower case.

45. The remote monitor as claimed in claim 1, further comprising a speaker for announcing a state of progress of the home appliance with a designated sound.

46. A remote monitor for a home appliance, the remote monitor being connected to at least one home appliance with a predetermined communication system for displaying, and controlling of a state of the home appliance at a place far from the home appliance, comprising:
a case forming an outside appearance of the remote monitor, including a lower case, an upper case detachably mounted on an upper side of the lower case, the upper case having a window, and an outer case detachably mounted on an upper side of the upper case, the outer case having a display window in correspondence to the window; and
a control board in the case, the control board having various electronic components mounted thereon.

47. The remote monitor as claimed in claim 46, further comprising a see-through sheet on an upper surface of the outer case, which is an exposed surface, for see-through an inside through the display window, and a protective sheet on an upper surface of the see-through sheet having a see-through window in correspondence to the display window on the outer case.

48. The remote monitor as claimed in claim 47, wherein the see-through sheet and the protective sheet have sizes in correspondence to the upper surface of the upper case, respectively.

49. The remote monitor as claimed in claim 47, wherein the see-through sheet is provided to be placed on the upper surface of the outer case, with a size corresponding to a size of the display window on the outer case, and
the protective sheet has a size in correspondence to the upper surface of the outer case.

50. The remote monitor as claimed in claim 47, wherein the see-through sheet is formed of PET (polyethylene terephthalate).

51. The remote monitor as claimed in claim 47, wherein the protective sheet is formed of a light metal, such as aluminum.

52. The remote monitor as claimed in claim 47, wherein the outer case includes an interference preventive groove in the upper surface of the outer case for preventing interference of burrs left at an edge of the protective sheet.
